(19) United States
(12) Patent Application Publication
(10) Pub. No.: US 2006/0163297 A1
(43) Pub. Date: Jul. 27, 2006

(54) Functional side rail roof rack

(75) Inventor: Serge Moreau, Newmarket (CA)

Correspondence Address: CLARK HILL, P.C., 500 WOODWARD AVENUE, SUITE 3500, DETROIT, MI, 48226, US

(73) Assignee: Magna International Inc., Aurora (CA)

(21) Appl. No.: 11/328,274

(22) Filed: Jan. 9, 2006

Related U.S. Application Data
(60) Provisional application No. 60/645,874, filed on Jan. 21, 2005.

(51) Int. Cl. B60R 9/00

(52) U.S. Cl. 224/321; 224/325

(57) ABSTRACT

A roof rack assembly is provided for a motor vehicle roof having a front support, a central support, and a rear support disposed along each longitudinal side thereof. The roof rack assembly includes a stationary rail fixedly secured to and extending longitudinally between the central and rear supports along each side of the roof. Each of the stationary rails defines a length. First and second adjustable rails are movable between a side rail position, in which the first and second adjustable rails extend longitudinally between the front support and the central support along each side of the roof, and a cross rail position, in which the first and second adjustable rails extend transversely across the roof. At least one of the first and second adjustable rails extends between the stationary rails for selective positioning along the length of the stationary rails.

### CROSS REFERENCE TO RELATED APPLICATION

This application claims priority to and all the benefits of U.S. Provisional Application Ser. No. 60/645,874, filed Jan. 21, 2005 and entitled “Functional Side Rail Roof Rack.”

### FIELD OF THE INVENTION

The invention relates to a roof rack assembly for a motor vehicle. More particularly, this invention relates to a roof rack assembly including adjustable rails movable between a side rail position and a cross rail position.

### Description of Related Art

Roof racks are commonly secured to or mounted above a roof of a motor vehicle for the storage and transport of articles. The storage of articles above the roof is beneficial in that additional passenger or storage space within an interior compartment of the motor vehicle is created. Roof racks are particularly useful for storing and transporting larger articles, such as bicycles and canoes, which would not otherwise fit within the interior compartment of the motor vehicle.

Typically, roof racks include a pair of spaced apart side rails extending longitudinally along the roof, and a pair of cross rails extending transversely across the roof between the pair of spaced apart side rails. Together, the side rails and cross rails provide a plurality of anchor points for securing articles to the roof rack. The cross rails generate, however, considerable wind noise during motor vehicle operation. While such wind noise is generally acceptable when-the cross rails are being utilized to store and transport articles, the same amount of wind noise is unacceptable during those instances when articles are not being secured to the cross rails.

### SUMMARY OF THE INVENTION

According to one aspect of the invention, a roof rack assembly is provided for a motor vehicle roof having a front support, a central support, and a rear support disposed along each longitudinal side. The roof rack assembly includes a stationary rail fixedly secured to and extending longitudinally between the central and rear supports along each side of the roof. Each of the stationary rails includes a length. First and second adjustable rails are movable between a side rail position, in which the first and second adjustable rails extend longitudinally between the front and central supports along the respective sides of the roof, and a cross rail position, in which the first and second adjustable rails extend transversely across the roof. At least one of the first and second adjustable rails extends between the stationary rails for selective positioning along the length of the stationary rails.

According to another aspect of the invention, a roof rack assembly is provided for a motor vehicle roof having a front edge, a rear edge, and a pair of spaced apart and longitudinal sides extending between the front and rear edges. The roof rack assembly includes a front support fixedly mounted along each side of the roof proximate the front edge thereof, a rear support fixedly mounted along each side of the roof adjacent the rear edge thereof, and a central support fixedly mounted along each side of the roof between the front and rear supports. The roof rack assembly also includes a stationary rail fixedly secured to and extending longitudinally between the rear and central supports along each side of the roof. Each of the stationary rails defines a channel. First and second adjustable rails are movable between a side rail position, in which each of the first and second adjustable rails extends longitudinally between the front and central supports along each side of the roof, and a cross rail position, in which the first and second adjustable rails extend transversely across the roof. At least one of the first and second adjustable rails slidingly engages the channel along the stationary rails for selective placement therealong.

According to yet another aspect of the invention, a roof rack assembly is provided for a motor vehicle roof having a front support, a central support, and a rear support fixedly mounted along each longitudinal side thereof. The roof rack assembly includes a stationary rail fixedly secured to and extending longitudinally between the central and rear supports along each side of the roof. First and second adjustable rails are movable between a side rail position, in which the first and second adjustable rails extend longitudinally between the front and central supports along each side of the roof, and a cross rail position, in which the first and second adjustable rails extend transversely across the roof. A rail attachment assembly is coupled to each of the first and second adjustable rails for locking the first and second adjustable rails in place in the side rail and cross rail positions.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a fragmentary, front perspective view of a motor vehicle including a roof rack assembly according to the invention having front, central, and rear supports, and first and second adjustable rails in a side rail position;

FIG. 2 is a fragmentary, rear perspective view of the motor vehicle including one of the first and second adjustable rails detached out of its side rail position;

FIG. 3 is a fragmentary, rear perspective view of the motor vehicle including the first and second adjustable rails in a cross rail position;

FIG. 4 is a perspective view of the front support;

FIG. 5 is a perspective view of the central support;

FIG. 6 is a perspective view of the rear support;

FIG. 7 is an exploded, perspective view of a rail attachment assembly for coupling to each end of the first and second adjustable rails;

FIG. 8 is a top view of the rail attachment assembly including a lever mechanism and an end cap;

FIG. 9 is a perspective view of the rail attachment assembly coupled to one end of the first adjustable rail with the lever mechanism movable between locked and unlocked positions; and

FIG. 10 is a side view of a tie-down accessory for coupling to one of the rails.

### DETAILED DESCRIPTION OF THE PREFERRED EMBODIMENT

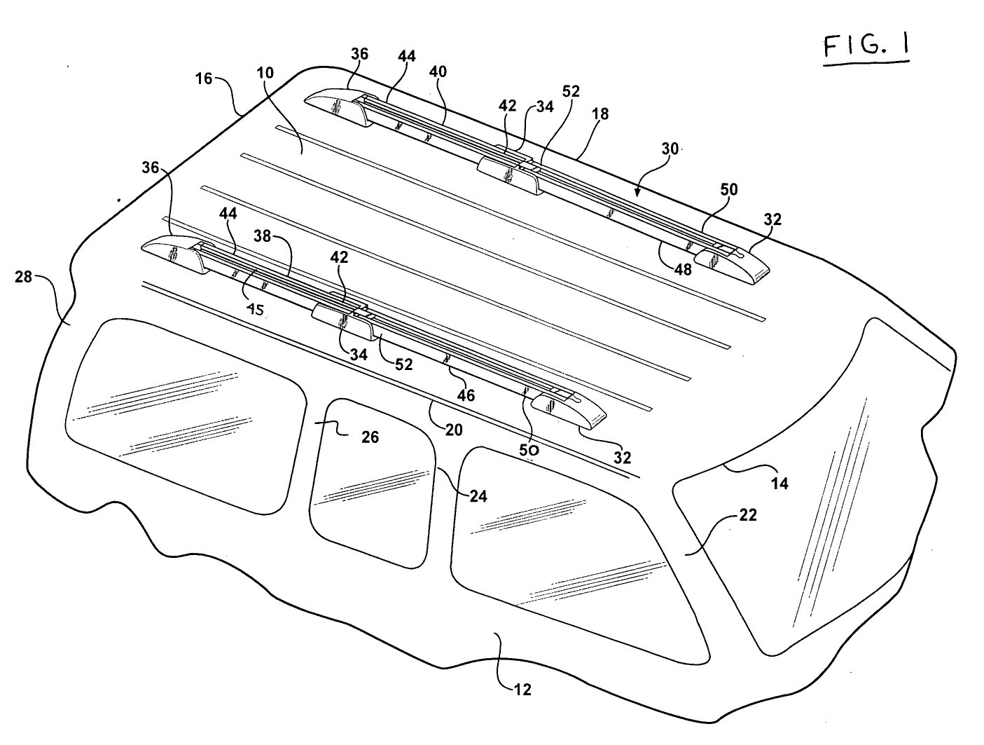

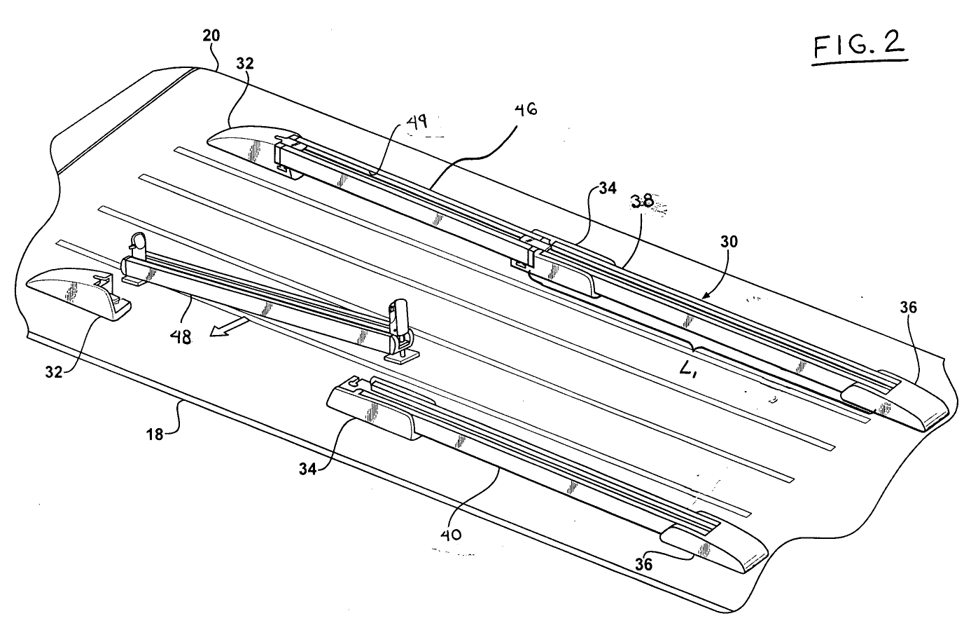

Referring to FIGS. 1 through 3, a roof 10 of a motor vehicle 12 includes a front edge 14, an opposing rear edge 16, and a pair of spaced apart sides 18, 20 extending longitudinally between the front 14 and rear 16 edges. The motor vehicle 12 includes an “A” pillar 22, a “B” pillar 24, a “C” pillar 26, and a rear pillar 28.

A roof rack assembly, generally shown at 30, is mounted along the roof 10 for storing articles thereabove. The roof rack assembly 30 includes a front support 32 fixedly mounted along each side 18, 20 of the roof 10. The front supports 32 are preferably mounted at a location between the “A” 22 and “B” 24 pillars along the sides 18, 20 of the roof 10. A central support 34 is fixedly mounted along each side 18, 20 of the roof 10 rearward of the front support 32. Preferably, the central supports 34 are mounted above the “C” pillar 26 along the sides 18, 20 of the roof 10. A rear support 36 is fixedly mounted along each side 18, 20 of the roof 10 above the rear pillar 28. The front 32, central 34, and rear 36 supports along each side 18, 20 of the roof 10 are preferably aligned with one another in a generally co-linear relationship.

The roof rack assembly 30 also includes a pair of stationary rails 38, 40 fixedly secured to and extending longitudinally between the central 34 and rear 36 supports. Each of the pair of stationary rails 38, 40 includes a front end 42 and a back end 44, and defines a length L₁ extending between the front 42 and back 44 ends. Each of the stationary rails 38, 40 defines a slide channel 45 extending at least partially along the length L₁ between the front 42 and back 44 ends.

The roof rack assembly 10 further includes first 46 and second 48 adjustable rails 46, 48 each extending between opposing ends 50, 52. Each of the first 46 and second 48 adjustable rails defines a channel 49 extending between the opposing ends 50, 52. The rails 38, 40, 46, 48 may be formed in any of numerous methods as known to those skilled in the art.

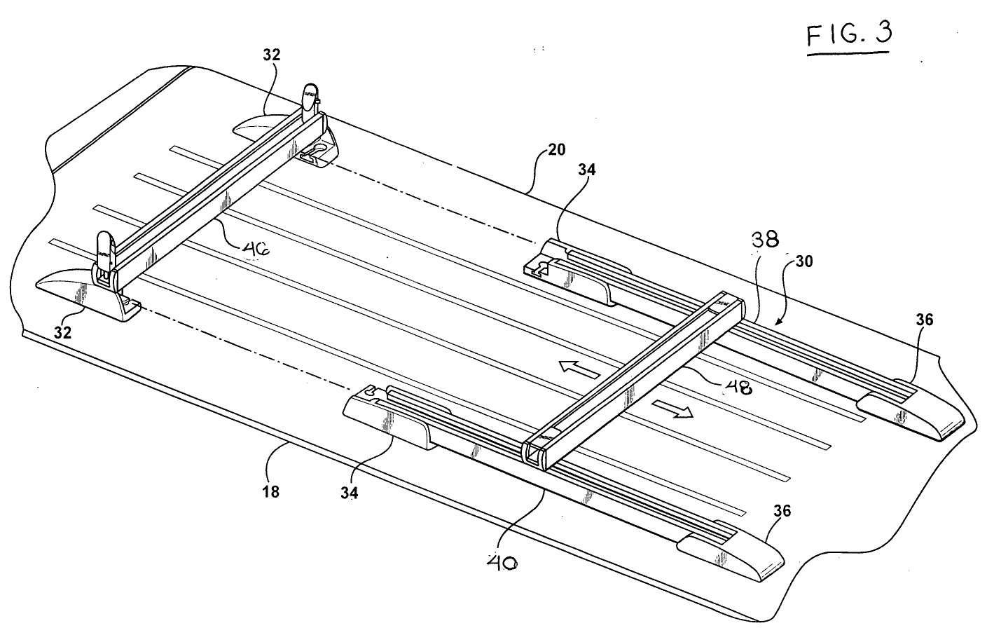

Each of the pair of adjustable rails 46, 48 is movable between a side rail position, shown in FIG. 1, and a cross rail position, shown in FIG. 3. In the side rail position, each of the first 46 and second 48 adjustable rails extends between one of the front supports 32 and one of the central supports 34 to provide a continuous rail extending along each side 18, 20 of the roof 10 between the front 14 and rear 16 edges thereof. In the cross rail position, each of the first 46 and second 48 adjustable rails extends transversely across the roof 10. More specifically, the first adjustable rail 46 extends transversely between the front supports 32, and the second adjustable rail 48 extends transversely between the stationary rails 38, 40. It is, however, appreciated that both the first 46 and second 48 adjustable rails could be positioned between the stationary rails 38, 40.

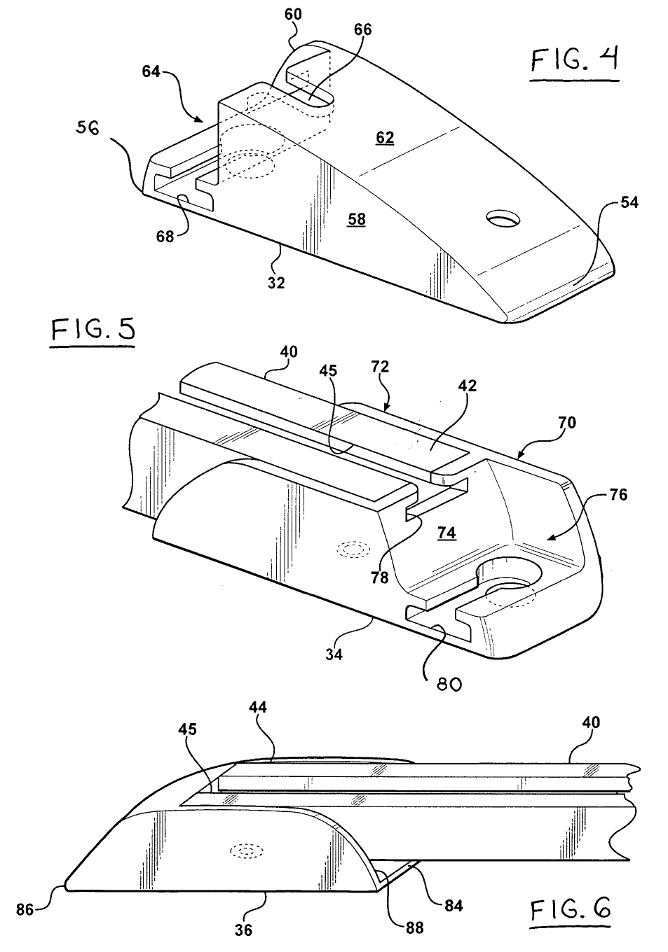

Referring to FIG. 4, each front support 32 extends between a front edge 54 and an opposing rear edge 56. The front support 32 includes an inboard wall 58, an outboard surface 60 that is viewable from outside the motor vehicle 12, and an upper surface 62. A rail receiving area, generally shown at 64, is located at the rear edge 56 of the front support 32. The rail receiving area 64 includes an upper slot 66 formed in the upper surface 62 and extending longitudinally. The upper slot 66 receives one end of one of the first 46 and second 48 adjustable rails when in the cross rail position. The rail receiving area 64 also includes a lower slot 68 formed in the inboard wall 58 and extending transversely relative to the upper slot 66. The lower slot 68 receives the same end 50 of one of the first 46 and second 48 adjustable rails when in the side rail position.

Referring to FIG. 5, each central support 34 includes a front portion 70, a rear portion 72, and a dividing wall 74 separating the front portion 70 from the rear portion 72. The front portion 70 includes a rail receiving area, generally shown at 76. The rail receiving area 76 includes an upper slot 78 extending longitudinally past the dividing wall 74, and a lower slot 80 extending transverse to the upper slot 78. The lower slot 80 receives one end 52 of one of the first 46 and second 48 adjustable rails when in the side rail position.

The rear portion 72 of the central support 34 defines an opening 82. The front end 42 of one of the stationary rails 38, 40 is received within the opening 82 and fixedly secured therewithin.

Referring to FIG. 6, each rear support 36 extends between a forward end 84 and an opposing rearward end 86. The rear support 36 defines an opening 88 extending generally between the forward 84 and rearward 86 ends. The back end 44 of one of the stationary rails 38, 40 is received within the opening 88 and fixedly secured therewithin.

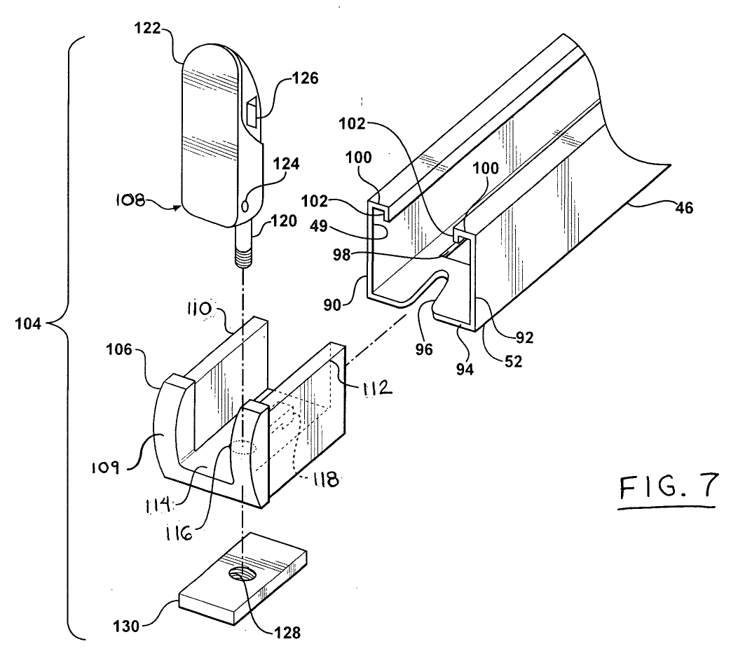

Referring to FIG. 7, each of the first 46 and second 48 adjustable rails includes a pair of spaced apart, longitudinally extending side members 90, 92 each extending longitudinally between the opposing ends 50, 52 (one shown.) A bottom member 94 extends between the spaced apart side members 90, 92. The bottom member 94 defines a slot 96 at both ends 50, 52 of each of the first 46 and second 48 adjustable rails. An engagement member 98 is disposed along the bottom member 94 inboard of the slot 96 at both ends 50, 52 of each of the first 46 and second 48 adjustable rails. An upper member 100 extends inwardly from each of the spaced apart side members 90, 92. A lock tab 102 extends out from each upper member 100.

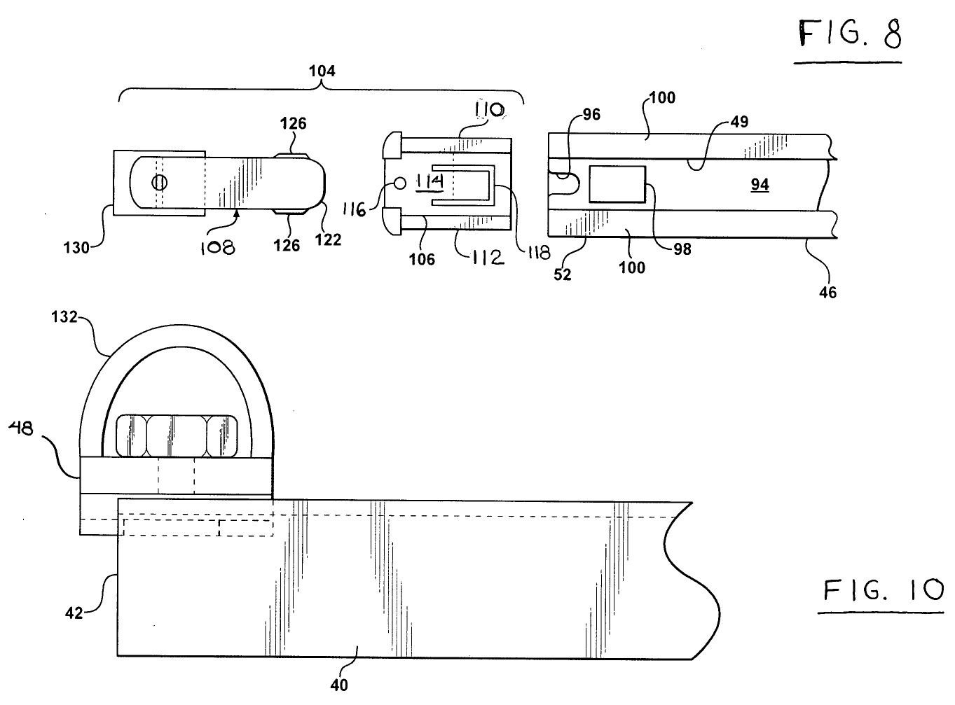

Referring to FIGS. 7 through 9, a rail attachment assembly, generally shown at 104, is coupled to both ends 50, 52 of each of the first 46 and second 48 adjustable rails for securing the first 46 and second 48 adjustable rails in either of the side rail and cross rail positions. The rail attachment assembly 104 includes an end cap 106 and a lever mechanism, generally indicated at 108. The end cap 106 is generally U-shaped and includes spaced apart side walls 110, 112 and a floor 114 extending therebetween. Each side wall 110, 112 is sized to fit within the space between one of the side members 94 and the adjacent lock tab 102 at each end 50, 52 of the first 46 and second 48 adjustable rails. The floor 114 includes an aperture 116 formed therethrough and a clip 118 is disposed inboard of the aperture 116. The end cap 106 further includes an outboard seal 109.

The lever mechanism 108 includes a rod 120, a lever 122 having a pair of resilient tabs 126 extending out therefrom, and a pivot pin 124 for providing pivotal movement of the lever 122 relative to the rod 120. The rod 120 extends through the aperture 116 in the bottom surface 114 of the end cap 106 and is fixed into place via threaded engagement with an aperture 128 in a plate 130. The plate 130 is sized to be selectively received within the upper 66 and lower 68 slots of the front support 32, and within the upper 78 and lower 80 slots of the central support 34 to effect attachment between the adjustable rails 46, 48 and the front 32 and central 34 supports.

To affix the rail attachment assembly 94 to the first 46 and second 48 adjustable rails, the end cap 106 is first inserted into one end 50, 52 of one of the first 46 and second 48 adjustable rails. The side walls 110, 112 of the end cap 106 fit within the space between the one of the side members 90, 92 and the adjacent lock tab 102. The rod 120 extending out from the plate 130 enters the slot 96 to allow full insertion of the end cap 106 into the adjustable rail 46, 48, that is, until the outboard seal 109 abuts one of the ends 50, 52.

To place one of the first 46 and second 48 adjustable rails in the side rail position, the ends 50, 52 are aligned with the respective front 32 and central 34 supports so that the plate 130 is aligned with the lower slots 68, 80. One plate 130 slidingly engages the lower slot 68 of the front support 32, and the other plate 130 slidingly engages the lower slot 80 of the central support 34. When the plates 130 are in engagement with the lower slots 68, 80, the lever 122 is pivoted about the pivot pin 122 from an unlocked position, as shown in FIG. 9B, to a locked position, shown in FIG. 9A, in which the pair of resilient tabs 126 is lockingly engaged beneath the respective lock tabs 102.

To place the first 46 and second 48 adjustable rails in the cross rail position, the plates 130 at each end of the first adjustable rail 46 are aligned with the upper slots 66 of the front supports 32. When each plate 130 is in engagement with one of the upper slots 66, the lever 122 pivots about the pivot pin 124 such that the pair of resilient tabs 126 is lockingly engaged beneath the respective lock tabs 102. At the same time, the plate 130 at each end 50, 52 of the second adjustable rail 48 is inserted through the upper slot 78 of each central support 34 and into sliding engagement with the channel 45 of each stationary rail 38, 40. The second adjustable rail 48 is locked into place at any of various locations between the front 42 and back 44 ends of the stationary rails 38, 40. It is appreciated that the first and second adjustable rail may be locked into place along the stationary rails 38, 40 in any of numerous methods as are known to those skilled in the art.

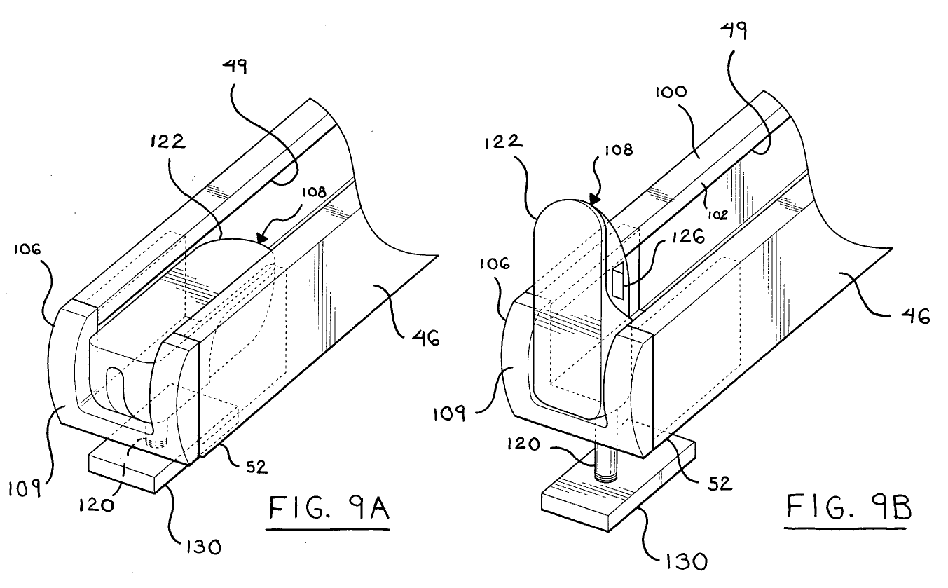

Referring to FIG. 10, a tie-loop accessory 132 may be installed along one of the rails 38, 40, 46, 48 and fixed into place in any of numerous ways. It is appreciated that any number of accessories or components may be similarly locked into place along the roof 10.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A roof rack assembly for a motor vehicle roof having a front support, a central support, and a rear support disposed along each longitudinal side thereof, said roof rack assembly comprising:
a stationary rail fixedly secured to and extending longitudinally between the central and rear supports along each side of the roof, each of said stationary rails having a length; and
first and second adjustable rails movable between a side rail position, in which said first and second adjustable rails extend longitudinally between the front and central supports along each side of the roof, and a cross rail position, in which said first and second adjustable rails extend transversely across the roof, at least one of said first and second adjustable rails extending between said stationary rails for selective positioning along said length of said stationary rails.

2. A roof rack assembly as set forth in claim 1 wherein each of said stationary rails defines a channel extending at least partially along said length for receiving one of said first and second adjustable rails.

3. A roof rack assembly as set forth in claim 2 wherein each of said first and second adjustable rails includes a pair of opposing ends.

4. A roof rack assembly as set forth in claim 3 including a rail attachment assembly coupled to said opposing ends of each of said first and second adjustable rails for locking each of said first and second adjustable rails in place in said side rail and cross rail positions.

5. A roof rack assembly as set forth in claim 4 wherein each of said rail attachment assemblies includes a plate slidingly engageable with said channel for positioning one end of said first and second adjustable rails along one of said stationary rails.

6. A roof rack assembly as set forth in claim 1 including a tie-loop accessory installed along at least one of the first and second adjustable rails.

7. A roof rack assembly for a motor vehicle roof having a front edge, a rear edge, and a pair of spaced apart and longitudinal sides extending between the front and rear edges, said roof rack assembly comprising:
a front support fixedly mounted along each side of the roof proximate the front edge thereof;
a rear support fixedly mounted along each side of the roof adjacent the rear edge thereof;
a central support fixedly mounted along each side of the roof between said front and rear supports;
a stationary rail fixedly secured to and extending longitudinally between said rear and central supports along each side of the roof, each of said stationary rails defining a channel; and
first and second adjustable rails movable between a side rail position, in which each of said first and second adjustable rails extends longitudinally between said front and central supports along each side of the roof, and a cross rail position, in which said first and second adjustable rails extend transversely across the roof, at least one of said first and second adjustable rails slidingly engaging said channel along said stationary rails for selective placement therealong.

8. A roof rack assembly as set forth in claim 7 wherein each of said first and second adjustable rails extends between opposing ends.

9. A roof rack assembly as set forth in claim 8 wherein each of said front supports includes a lower slot for receiving one end of one of said first and second adjustable rails in the side rail position.

10. A roof rack assembly as set forth in claim 9 wherein each of said central supports includes a lower slot for receiving an opposing end of one of said first and second adjustable rails in the side rail position.

11. A roof rack assembly as set forth in claim 10 including a rail attachment assembly coupled to said opposing ends of each of said first and second adjustable rails for locking each of said first and second adjustable rails in place in said side rail and cross rail positions.

12. A roof rack assembly as set forth in claim 8 wherein each of said front supports includes an upper slot for receiving one end of one of said first and second adjustable rails to support said one of said first and second adjustable rails extending transversely between said front supports.

13. A roof rack assembly for a motor vehicle roof having a front support, a central support, and a rear support fixedly mounted along each longitudinal side thereof, said roof rack assembly comprising:
a stationary rail fixedly secured to and extending longitudinally between the central and rear supports along each side of the roof;
first and second adjustable rails movable between a side rail position, in which said first and second adjustable rails extend longitudinally between the front and central supports along the respective sides, and a cross rail position, in which said first and second adjustable rails extend transversely across the roof, at least one of the first and second adjustable rails extends between said stationary rails; and
a rail attachment assembly coupled to each of said first and second adjustable rails for locking said first and second adjustable rails in place in said side rail and cross rail positions.

14. A roof rack assembly as set forth in claim 13 wherein each of said first and second adjustable rails includes opposing ends.

15. A roof rack assembly as set forth in claim 14 wherein each of said rail attachment assemblies includes a lever pivotally secured to said rod for selectively locking one of said first and second adjustable rails in one of said side rail and cross rail positions.

16. A roof rack assembly as set forth in claim 15 wherein each of said first and second adjustable rails defines a channel extending therealong.

17. A roof rack assembly as set forth in claim 16 wherein each of said first and second rail attachment assemblies includes resilient tabs extending out from said lever for selective locking engagement within said channel.

18. A roof rack assembly as set forth in claim 17 wherein each of said rail attachment assemblies includes an end cap coupled to said opposing ends of each of said first and second adjustable rails.
